(19) United States
(12) Patent Application Publication
(10) Pub. No.: US 2014/0227965 A1
(43) Pub. Date: Aug. 14, 2014

(54) RELAY DEVICE

(71) Applicants: Tokunori Kageyama, Tokyo (JP); Hiroaki Miyamoto, Tokyo (JP)

(72) Inventors: Tokunori Kageyama, Tokyo (JP); Hiroaki Miyamoto, Tokyo (JP)

(21) Appl. No.: 14/117,252

(22) PCT Filed: May 14, 2012
(86) PCT No.: PCT/JP2012/062320

§ 371 Date: Nov. 12, 2013

(30) Foreign Application Priority Data
May 12, 2011 (JP) 2011-107046

(51) Int. Cl. H04B 7/155

(52) U.S. Cl. CPC H04B 7/15535
USPC 455/9

(57) ABSTRACT

A relay device relays transmittance of information between a wire communication line and a wireless communication line. The relay device includes: a modulation unit which modulates information to be transmitted into an electrical signal; and a control unit which controls an operation of the modulation unit. The control unit controls a modulation system of the modulation unit in accordance with traffic of the wire communication line.

### TECHNICAL FIELD

The present invention relates to a relay device. In particular, it relates to a relay device that relays transmittance of information between a wire communication line and a wireless communication line.

### BACKGROUND ART

Among known relay devices in a network system, there is known one that suitably modulates using a higher modulation multi-level number the better the propagation state of a wireless communication line, so as to be able to transmit data at the highest transmission rate.

For example, a known relay device provides a high transmission rate by modulating with a high multi-level number when the propagation path state is good. On the other hand, when the propagation path state is in a bad state, it modulates with a low multi-level number so as to be able to certainly propagate even if the transmission rate is low (for example, refer to Patent Documents 1 and 2).

Patent Document 3 discloses a modulation system control method in a transmitting/receiving device that uses an adaptive modulation method that transmits by switching between a plurality of modulation systems. In this modulation system control method, the transmitting/receiving device estimates the propagation path state based on the received signal, and decides as a first modulation system a modulation system that satisfies a transmission quality of a certain standard and that leads to the maximum transmission speed in that propagation path state. Also, this modulation system control method detects the traffic amount of transmission data, and determines as a second modulation system the transmission system that leads to the lowest transmission speed at which the traffic amount is transmittable. Then, this modulation system control method selects as the transmission modulation system either the first modulation system or the second modulation system whose transmission speed is lower.

### PRIOR ART DOCUMENTS

### Patent Document

[Patent Document 1] PCT International. Publication No. WO 2007/141878 pamphlet

[Patent Document 2] PCT International Publication No. WO 2006/075585 pamphlet

[Patent Document 3] Japanese Unexamined Patent Application, First Publication No. 2006-165939

### SUMMARY OF THE INVENTION

### Problem to be Solved by the Invention

However, the technology of Patent Documents 1 and 2 decides the modulation system based on the propagation state of the wireless communication line, and so performs wireless communication with the largest multi-level modulation, in the case of the propagation state being monitored as good even when the transmission data amount is small, or when there is no transmission data. For that reason, in the case of the propagation path state being monitored as good, due to outputting an output signal with the maximum transmission power that enables the largest multi-level modulation transmission, regardless of the presence of transmission data or the traffic being heavy or light, there is the problem of the power consumption of a wireless device being increased.

As for the technology disclosed in Patent Document 3, in the case of the line quality being bad when a large quantity of data is flowed from a wire LAN side, due to priority being given to control by line quality information, there is the risk of a delay in the data processing occurring.

### Means for Solving the Problem

In order to solve the aforementioned problems, a relay device relays transmittance of information between a wire communication line and a wireless communication line. The relay device includes: a modulation unit which modulates information to be transmitted into an electrical signal; and a control unit which controls an operation of the modulation unit. The control unit controls a modulation system of the modulation unit in accordance with traffic of the wire communication line.

The above disclosure does not list all of the necessary characteristics of the present invention. Sub-combinations of this group of characteristics may become inventions.

### Effect of the Invention

According to the present invention, it is possible to perform data transmission. with the minimum transmission power necessary, in the case of there being little traffic, and in the case of there being no traffic.

### BRIEF DESCRIPTION OF THE DRAWINGS

FIG. 1 is a diagram that shows an example of the communication system according to an exemplary embodiment of the present invention.

FIG. 2 is a block diagram that shows a detailed configuration example of a transmission path monitoring unit shown in FIG. 1.

FIG. 3 is a time chart of an electric power control in the case of there being little traffic by the communication system shown in FIG. 1.

FIG. 4 is a time chart of an electric power control in the case of the traffic by the communication system shown in FIG. 1 changing from light to heavy.

FIG. 5 is a time chart of an electric power control in the case of the traffic by the communication system shown in FIG. 1 changing from heavy to intermediate.

FIG. 6 is a block diagram that shows an example of a communication system according to another exemplary embodiment of the present invention.

FIG. 7 is a time chart of an electric power control in the communication system shown in FIG. 6.

### EMBODIMENTS FOR CARRYING OUT THE INVENTION

Hereinbelow, the present invention shall be described through exemplary embodiments of the present invention, but the following exemplary embodiments shall not limit the invention recited in claims. Also, not all of the combinations of the characteristics described in the exemplary embodiments may be necessary for the means for solving the problems of the present invention.

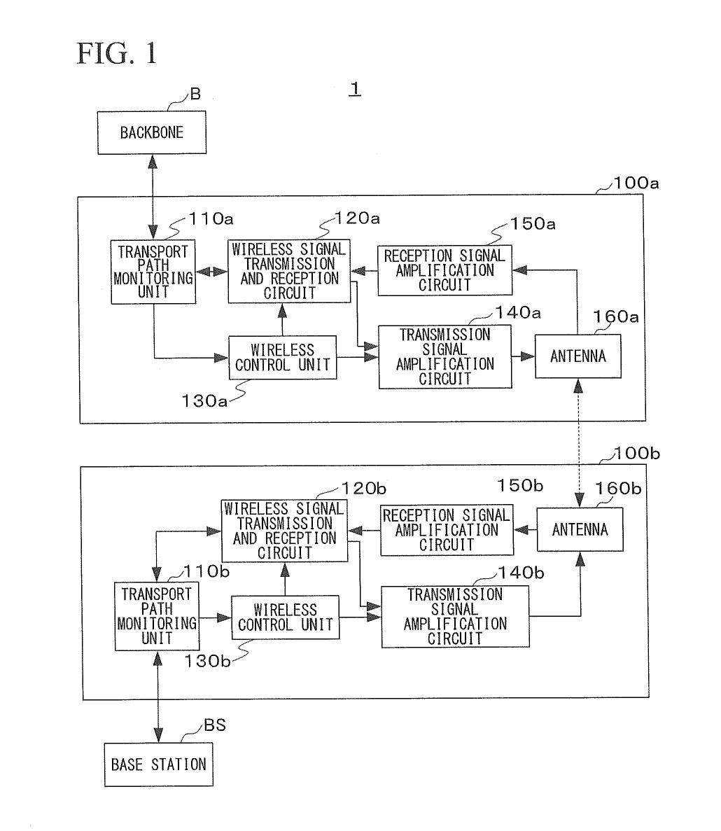

FIG. 1 shows an example of the communication system 1 according to an exemplary embodiment of the present invention. The communication system 1 includes two relay devices 100a and 100b (hereinbelow collectively referred to as relay devices 100). The relay device 100a and the relay device 100b are communicably connected via a wireless communication line. The relay device 100a is communicably connected via a wire communication line with a backbone B. The relay device 100b is communicably connected via a wire communication line with a base station BS. The backbone B is a high-volume trunk communication line that connects telecommunications carriers. The base station BS is a device that corresponds to a terminal of a mobile telephone network, which communicates directly with mobile telephones.

The relay device 100a includes a transport path monitoring unit 110a, a wireless signal transmission and reception circuit 120a, a wireless control unit 130a, a transmission signal amplification circuit 140a, a reception signal amplification circuit 150a, and an antenna 160a. Hereinbelow, the function and operation of each constituent element shall be described.

The relay device 100b includes the same constituent elements as the constituent elements that the relay device 100a includes. That is to say, the relay device 100b includes a transport path monitoring unit 110b, a wireless signal transmission and reception circuit 120b, a wireless control unit 130b, a transmission signal amplification circuit 140b, a reception signal amplification circuit 150b, and an antenna 160b.

Hereinbelow, when describing the constituent elements of the relay device 100a and the constituent elements of the relay device 100b with no distinction, the constituent elements are expressed without the symbols “a” or “b”. For example, when describing the transport path monitoring unit 110a and the transport path monitoring unit 110b without distinction, they are collectively referred to as transport path monitoring unit 110.

The transport path monitoring unit 110 monitors the traffic of transmission signals of the wire LAN that connects the relay device 100 and the backbone B or the base station BS, and transports the monitoring information to the wireless control unit 130. The wireless signal transmission and reception circuit 102 modulates/demodulates and encodes/decodes the transport data. The wireless control unit 130 performs control of the modulation/demodulation method and encoding/decoding rate, and amplification control of the transmission signal amplification circuit 140. The transmission signal amplification circuit 140 amplifies the transmission signal. The reception signal amplification circuit 150 amplifies the reception signal.

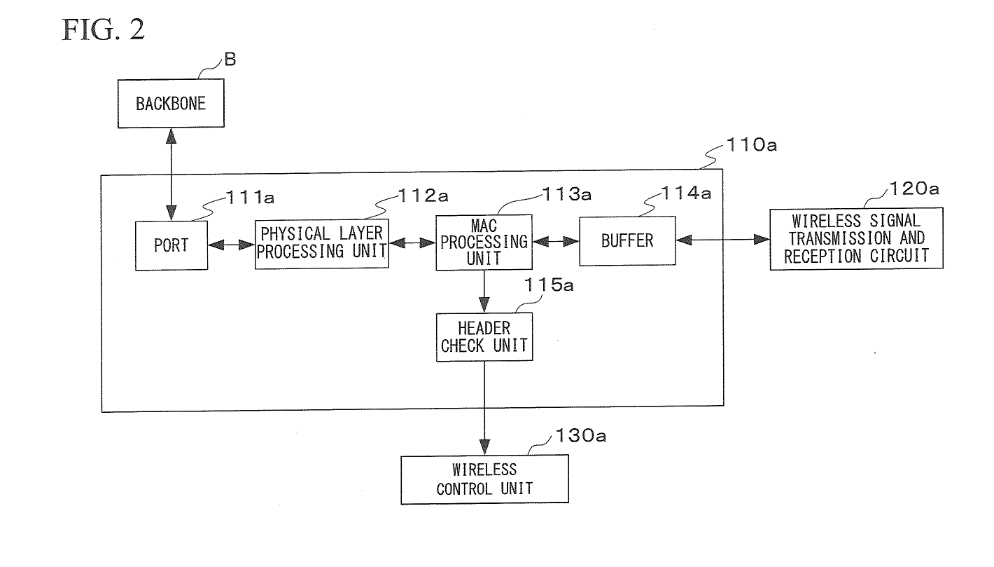

FIG. 2 is a block diagram that shows a detailed constitution example of the transport path monitoring unit 110. More specifically, FIG. 2 shows a block diagram that depicts a detailed constitution example of the transport path monitoring unit 110a. Although not shown, the internal structure of the transport path monitoring unit 110b is the same as the internal structure of the transport path monitoring unit 110a shown in FIG. 2.

A port 111 is an interface for performing input and output of data between the wire LAN and the relay device. A physical layer processing unit 112 modulates/demodulates the analog signal that is transmitted to/received from the wire LAN. The MAC processing unit 113 monitors control information such as addresses and performs control of the frame signal. A buffer 114 temporarily holds the data that has been transported and then transports it. The buffer 114 has known technology that transmits a pause signal to the wire LAN side to temporarily lower the transmission rate of the wire LAN side in the case of the amount of data that has been transported being large, and the amount of free memory running low. A header check unit 115 monitors traffic by reading the data length portion of the header within the unit time from the MAC processing unit 113.

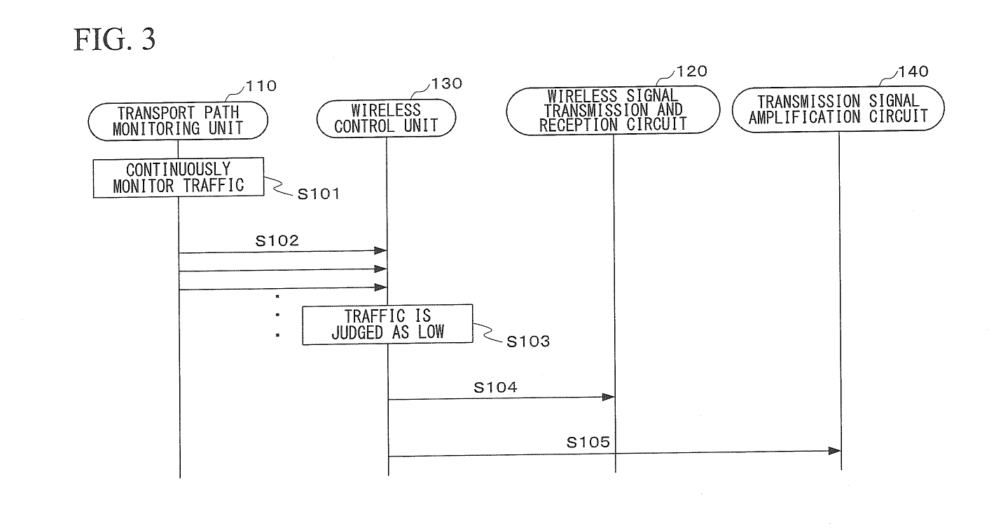

Referring to the time chart shown in FIG. 3, the case shall be described of the wireless control unit 130 judging the transmission signal traffic as low from the monitoring information of the transport path monitoring unit 110, and selecting the QPSK (quadrature phase shift keying), which has the minimum necessary modulation multi-level number.

The transport path monitoring unit 110 continuously monitors the traffic of transmission signals of the wire LAN (S101), and continues to send the monitoring information to the wireless control unit 130 (S102: Transmit monitoring information at anytime).

In the case of the traffic of transmission signals being low, the wireless control unit 130 judges the traffic of transmission signals as being low based on the monitoring information sent from the transport path monitoring unit 110 (S103), and selects the QPSK, which has the minimum necessary modulation multi-level number, for allowing data transmission from the relay device 100a (or 100b) to the relay device 100b (or 100a).

When the wireless control unit 130 judges the traffic of transmission signals to be low and determines the modulation multi-level number, it judges the traffic based on multiple instances of the monitoring information from the monitoring information so that there is no main signal phase fluctuation.

The wireless control unit 130 transmits the modulation multi-level number information to the wireless signal transmission and reception circuit 120 as the QPSK (S104: Control information by QPSK).

Also, the wireless control unit 130 transmits transmission power control information to the transmission signal amplification circuit 140 so that data transmission is possible from the relay device 100a (or 100b) to the relay device 100b (or 100a) by the QPSK, in which the modulation multi-level number is low, and so that the data is to be transmitted with the minimum necessary power (S105: Transmission power control information).

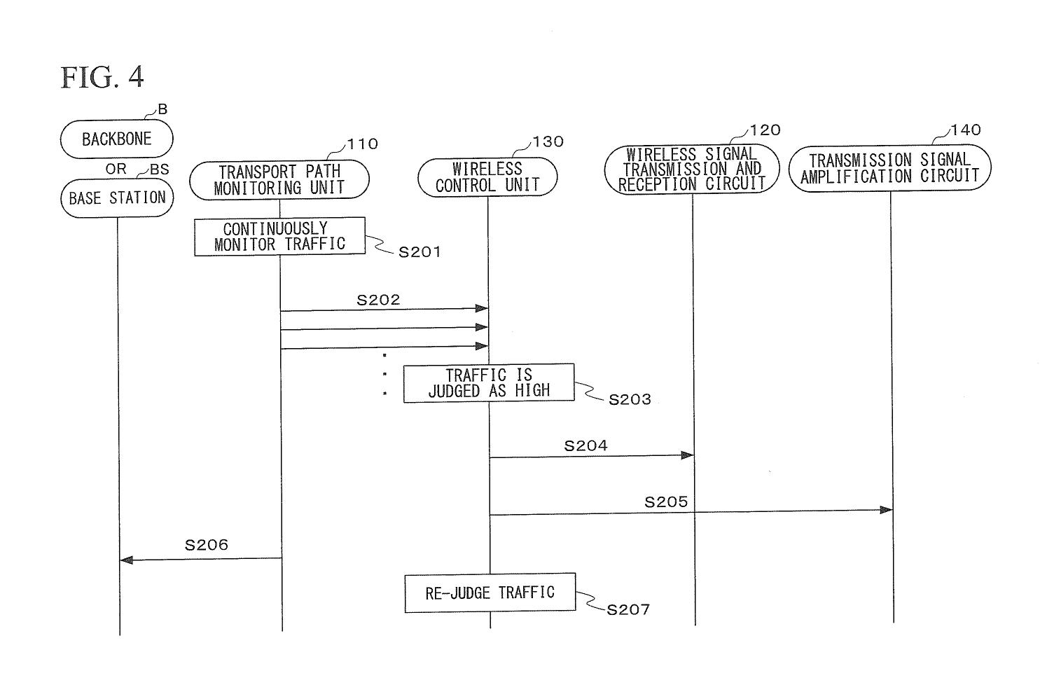

Next, referring to the time chart shown in FIG. 4, the case shall be described of the traffic of wire LAN transmission signals increasing from low to high, and the wireless control unit 130 judging the transmission signal traffic to be high from the monitoring information of the transport path monitoring unit 110 and selecting the 256-QAM (quadrature amplitude modulation), which has the minimum necessary modulation multi-level number.

The transport path monitoring unit 110 continuously monitors traffic of wire LAN transmission signals (S201), and continues to send the monitoring information to the wireless control unit 130 (S202: Transmit monitoring information at anytime).

In the case of the transmission signal traffic increasing from low to high, the wireless control unit 130, based on the monitoring information sent from the transport path monitoring unit 110, judges the transmission signal traffic to have increased to high (S203), and selects the 256-QAM, which has the minimum necessary modulation multi-level number, for allowing data transmission from the relay device 100a (or 100b) to the relay device 100b (or 100a). In the case of the transmission signal traffic having increased, the wireless control unit 130 immediately determines the modulation multi-level number from the monitoring information so that there is no main signal phase fluctuation.

The wireless control unit 130 transmits as the 256-QAM the modulation multi-level number information to the wireless signal transmission and reception circuit 120 (S204: Control information by 256-QAM).

Also, the wireless control unit 130 transmits transmission power control information to the transmission signal amplification circuit 140 so that data transmission is possible from the relay device 100a (or 100b) to the relay device 100b (or 100a) by the 256-QAM, which has a high modulation multi-level number, and so that the data is to be transmitted with the minimum necessary power (S205: Transmission power control information).

In the case of the wire LAN transmission signal traffic being too high, the transport path monitoring unit 110 transmits a pause signal to the wire LAN side to temporarily stop the wire LAN transmission signals, and thereby temporarily lower the transmission rate of transmission signals (S206).

In the case of the pause signal having been transmitted, due to the transmission rate of wire LAN transmission signals temporarily falling, the wireless control unit 130 judges the traffic based on multiple instances of the monitoring information from the monitoring information so that there is no main signal phase fluctuation (S207).

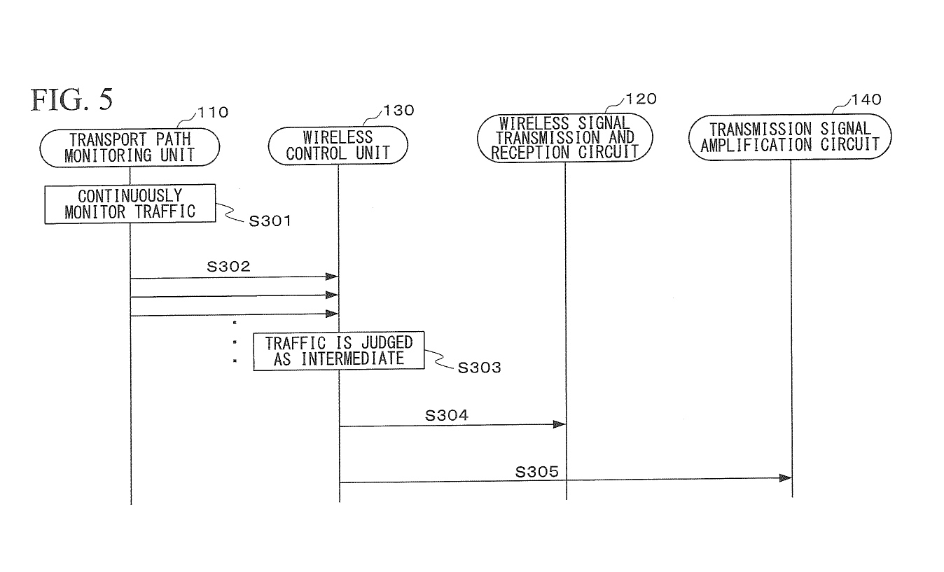

Next, referring to the time chart shown in FIG. 5, the case shall be described of the traffic of wire LAN transmission signals decreasing from high to intermediate, and the wireless control unit 130 judging the transmission signal traffic to be intermediate from the monitoring information of the transport path monitoring unit 110 and selecting the 64-QAM, which has the minimum necessary modulation multi-level number.

The transport path monitoring unit 110 continuously monitors traffic of wire LAN transmission signals (S301), and continues to send the monitoring information to the wireless control unit 130 (S302: Transmit monitoring information at anytime).

In the case of the transmission signal traffic decreasing from high to intermediate, the wireless control unit 130, based on the monitoring information sent from the transport path monitoring unit 110, judges the transmission signal traffic to have decreased to intermediate (S503), and selects the 64-QAM, which has the minimum necessary modulation multi-level number, for allowing data transmission from the relay device 100a (or 100b) to the relay device 100b (or 100a). In the case of the traffic decreasing and the wireless control unit 130 selecting a modulation system with a small multi-level number, the wireless control unit 130 judges the traffic based on multiple instances of monitoring information from the monitoring information so that there is no main signal phase fluctuation.

The wireless control unit 130 transmits as the 64-QAM the modulation multi-level number information to the wireless signal transmission and reception circuit 120 (S304).

The wireless control unit 130 transmits transmission power control information to the transmission signal amplification circuit 140 so that data transmission is possible from the relay device 100a (or 100b) to the relay device 100b (or 100a) by the 64-QAM, which has an intermediate modulation multi-level number, and so that the data is to be transmitted with the minimum necessary power (S305: Transmission power control information).

In order to simplify the description in the operations of the present exemplary embodiment, the traffic states are divided into the three cases of low, intermediate and high. Also, the case of low traffic is made to correspond with the QPSK having a low modulation multi-level number. The case of intermediate traffic is made to correspond with the 64-QAM having an intermediate modulation multi-level number. The case of high traffic is made to correspond with the 256-QAM having a high modulation multi-level number. In reality, since there are general modulation multi-level numbers (QPSK, 16-QAM, 64-QAM, 128-QAM, 256-QAM, 516-QAM and the like) and various code rates, settings for further segmented traffic are possible.

An operation of monitoring wire LAN traffic and performing wireless bandwidth control in FIG. 1 shall be described referring to FIG. 2.

The port 111 takes in wire LAN transmission signals to the transport path monitoring unit 110, and transmits the transmission signals to the physical layer processing unit 112.

The physical layer processing unit 112 demodulates the analog signal that is transmitted from the wire LAN side, and transmits the demodulated signal to the MAC processing unit 113.

The MAC processing unit 113 monitors control information such as the address of the demodulated signal and the like, and transmits the frame signal to the buffer 114. After temporarily holding the data of the frame signal, the buffer 114 transmits it to the wireless signal transmission and reception circuit 120. Also, the buffer 114 has a known bandwidth control technology that, in the case of the data mount of the frame signal being high, leading to the amount of free space running low, transmits a pause signal to the wire LAN side to temporarily stop the transmission signal of the wire LAN, and thereby temporarily lower the transmission rate of transmission signals.

The header check unit 115 judges the transmission rate by reading the data length portion of the header within a unit time from the MAC processing unit 113, and transmits the traffic monitoring information (S102) to the wireless control unit 130.

The wireless control unit 130 that has received the monitoring information (S102) judges the minimum necessary modulation multi-level number for data transmission.

By the aforementioned steps, the transport path monitoring unit 110 monitors the wire LAN traffic, and based on the monitored traffic can secure the minimum necessary wireless band

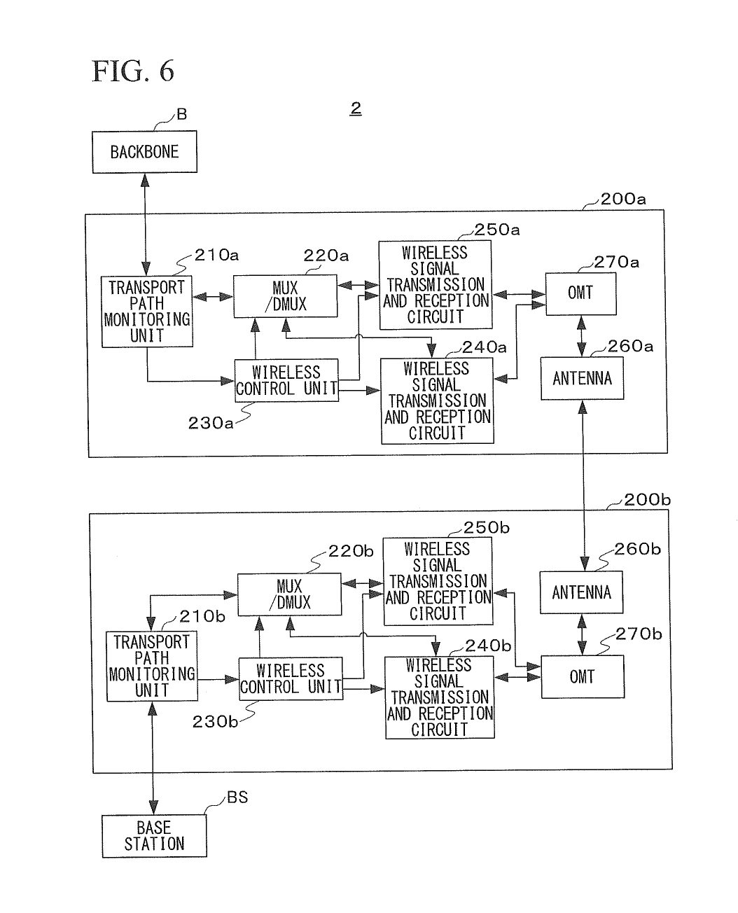

FIG. 6 shows another exemplary embodiment of the present invention applied to an XPIC (Cross Polarization Interference Canceller). FIG. 6 shows a wireless communication system that is constituted from a relay device 200a and a relay device 200b. The internal structures of the relay device 200a and the relay device 200b shown in FIG. 6 are the same. Hereinbelow, when describing the constituent elements of the relay device 200a and the constituent elements of the relay device 200b with no distinction, the constituent elements are expressed without the symbols “a” or “b”. For example, when describing the transport path monitoring unit 210a and the transport path monitoring unit 210b without distinction, they are collectively referred to as transport path monitoring unit 210.

The transport path monitoring unit 210 continuously continues to monitor the traffic of the wire LAN that connects the relay device 200 and the backbone B or the base station BS, and transmits the monitoring information to the wireless control unit 230. The wireless control unit 230 transmits the transmission system information to a MUX (multiplexer)/DMUX (demultiplexer) 220 and wireless signal transmission and reception circuits 240 and 250. The MUX/DMUX 220 multiplexes/demultiplexes the transmission and reception signals by the selected transmission system (2 transmissions or 1 transmission). The wireless signal transmission and reception circuit 240 and the wireless signal transmission and reception circuit 250 perform modulation/demodulation and encoding/decoding of signals by the selected transmission system (active/inactive). An OMT (orthogonal mode transducer) 270 orthogonally couples/separates the transmission and reception signals that is transmitted and received via an antenna 260.

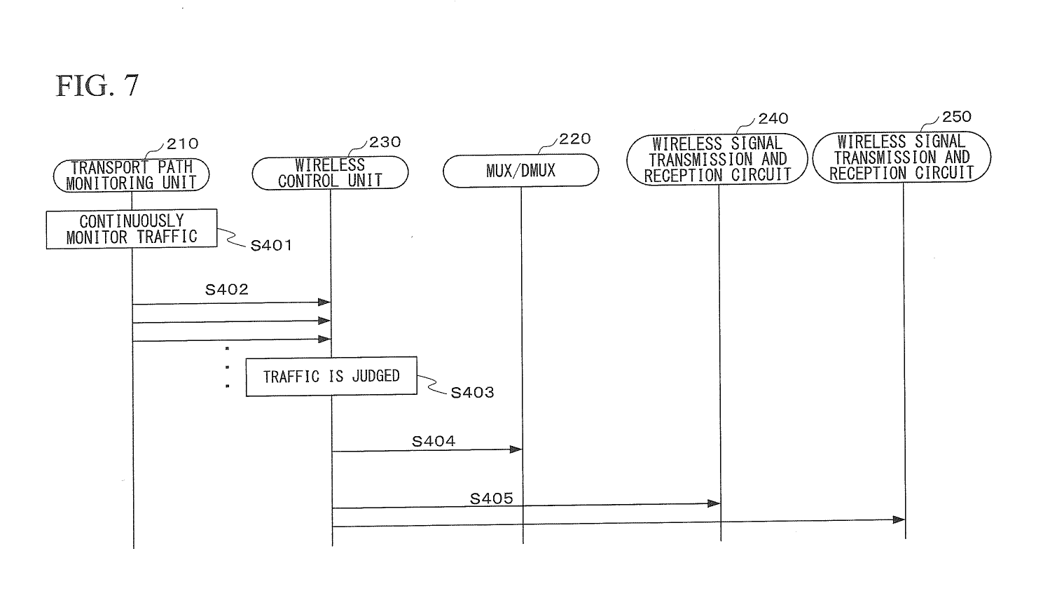

An operation in the constitution of FIG. 6 shall be described referring to the time chart shown in FIG. 7. The transport path monitoring unit 210 continuously monitors the traffic of transmission signals of the wire LAN (S401) and continuously transmits the monitoring information to the wireless control unit 230 (S402: Transmit monitoring information at anytime).

The wireless control unit 230 judges the traffic of transmission signals based on the monitoring information (S403), and selects the minimum necessary transmission system information in which transmission is possible to the relay device 200b. The wireless control unit 230 sends to the MUX/DMUX 220 transmission system information that shows whether to perform both sides 2 transmission or single side 1 transmission of the signal to be transmitted to the wireless signal transmission and reception circuit 240 and the wireless signal transmission and reception circuit 250 (S404: Transmit transmission system information).

The wireless control unit 230 transmits to the wireless signal transmission and reception circuit 240 and the wireless signal transmission and reception circuit 250 the minimum necessary modulation multi-level number information for allowing notification of the transmission system information relating to active/inactive and data transmission (S405: Transmit transmission system information (active/inactive)+modulation multi-level number information).

As described above, based on the monitoring information in which the transmission path monitoring unit 210 has monitored wire LAN traffic, the wireless control unit 230 carries out XPIC control, whereby compared with the basic constitution shown in FIG. 1, transmission and reception with an increased transmission rate become possible with the minimum necessary power consumption.

As described above, according to the exemplary embodiments of the present invention, it is possible to perform data transmission with the minimum necessary transmission power in the case of there being little traffic or no traffic.

Also, according to the exemplary embodiments of the present invention, since it is possible to independently control an adaptive multi-level number in the incoming direction or outgoing direction in which data is transmitted, it is possible to set the transmission power of the incoming relay device and the outgoing relay device to a minimum, and therefore possible to lower the power consumption of the entire system.

Hereinabove, while the invention has been described with reference to the exemplary embodiments thereof, the invention is not limited to these exemplary embodiments. It is possible to make various changes to the constitutions and details of the present invention that can be understood by a person skilled in the art within the scope of the present invention.

This application is based upon and claims the benefit of priority from Japanese patent application No. 2011-107046, filed May 12, 2011, the disclosure of which is incorporated herein in its entirety by reference.

### INDUSTRIAL APPLICABILITY

The present invention may be applied to a relay device. According to the relay device that has applied the present invention, it is possible to perform data transmission with the minimum necessary transmission power in the case of there being little traffic or no traffic.

### REFERENCE SYMBOLS

1 Transmission system
2 Transmission system
100 Relay device
110 Transport path monitoring unit
120 Wireless signal transmission and reception circuit
130 Wireless control unit
140 Transmission signal amplification circuit
150 Reception signal amplification circuit
160 Antenna
200 Relay device
210 Transport path monitoring unit
220 MUX/DMUX
230 Wireless control unit
240 Wireless signal transmission and reception circuit
250 Wireless signal transmission and reception circuit
260 Antenna
270 OMT

1. A relay device which relays transmittance of information between a wire communication line and a wireless communication line, the relay device comprising:
a modulation unit which modulates information to be transmitted into an electrical signal; and
a control unit which controls an operation of the modulation unit,
the control unit controlling a modulation system of the modulation unit in accordance with traffic of the wire communication line.

2. The relay device according to claim 1, further comprising:
a monitoring unit which monitors the traffic of the wire communication line,
wherein the control unit controls the modulation system of the modulation unit in accordance with the traffic monitored by the monitoring unit.

3. The relay device according to claim 1, further comprising:
an amplification unit which amplifies the electrical signal obtained by the modulation of the modulation unit,
wherein the control unit controls an operation of the amplification unit so that the electrical signal obtained by the modulation by the controlled modulation system of the modulation unit is set to a minimum electric power value which makes it possible to transmit the electrical signal to another relay device.

4. The relay device according to claim 1, wherein the control unit transmits to a transmission source of information on a wire communication line side a signal for requesting stoppage of transmission of the information in a case where the traffic of the wire communication line is equal to or greater than a threshold value.

5. The relay device according to claim 1, further comprising:
a multiplexing unit which multiplexes transmission signals; and
a plurality of the modulation units which modulate a transmission signal obtained by the multiplexing of the multiplexing unit,
wherein the control unit controls the multiplexing unit so as to multiplex by a transmission system which depends on the number of the modulation units to be used in accordance with the traffic of the wire communication line.
